(19) United States
(12) Patent Application Publication
(10) Pub. No.: US 2026/0002043 A1
(43) Pub. Date: Jan. 1, 2026

(54) POLYMER FILMS

(71) Applicant: Reckitt Benckiser Finish B.V., Hoofddorp (NL)

(72) Inventors: Alias Younis Al-Bayati, Heidelberg (DE); Sascha FUHRMANN, Heidelberg (DE); Naomi MARKHAM, Heidelberg (DE); Claudia SCHMAELZLE, Heidelberg (DE); Divya VARADHARAJAN, Heidelberg (DE); Nils WEDLER, Heidelberg (DE); Qingcai ZHAO, Heidelberg (DE)

(21) Appl. No.: 18/867,714

(22) PCT Filed: May 22, 2023
(86) PCT No.: PCT/EP2023/063684

§ 371 Date: Nov. 20, 2024

(30) Foreign Application Priority Data
May 23, 2022 (GB) 2207487.6

(51) Int. Cl. C09D 129/04; C09D 189/00

(52) U.S. Cl. CPC C09D 129/04; C09D 189/00

(57) ABSTRACT

The invention relates to a coated water-soluble film comprising a water-soluble polymer base film and a water-soluble coating comprising at least one amphiphilic polymer; wherein the base film comprises polyvinyl alcohol. The invention is further related to a water-soluble unit dose article comprising a composition packaged in a container comprising such a coated water-soluble film; the use of such a water-soluble unit dose article as a hard surface cleaner, a descaler, a toilet cleaner, a dishwashing machine cleaner, a household care composition, or a multi-purpose cleaner. Additionally, the invention is related to a method of preparing such a coated water-soluble film comprising the method steps of providing a water-soluble polymer base film; and coating the base film with at least one amphiphilic polymer.

### TECHNICAL FIELD OF THE INVENTION

The present invention relates to coated water-soluble films, water-soluble unit dose articles, methods of preparing the above, and uses of water-soluble unit dose articles.

### BACKGROUND TO THE INVENTION

Water-soluble polymer films are commonly used as packaging materials to simplify dispersing, pouring, dissolving, and dosing of a material to be delivered. A consumer can, for example, directly add a composition packaged in a water-soluble polymer film to a mixing vessel, such as a bucket, sink, or washing machine. Advantageously, this provides for accurate dosing while eliminating the need for the consumer to measure the composition. Additionally, the water-soluble polymeric film packaging can separate otherwise strong chemistries from the consumer's hand, protecting the consumer from contacting reactive chemicals. The packaged composition may also reduce mess that would be associated with dispensing a similar composition from a vessel, such as pouring a composition from a bottle. In summary, soluble pre-measured polymeric film packages provide for convenience and safety for the consumer in a variety of applications.

Some water-soluble polymeric films that are used to make currently marketed packaging pouches interact with the pouch components (e.g., oxidants, acids, bases or the like), which affects the properties of the pouch, for example the solubility of the film, particularly after storage. For example, pouches may demonstrate reduced film solubility over time when in contact with contents therein. Such reduced solubility can, for example, result in significant amounts of residue remaining after the contents of the pouch have been dispersed. In other cases, the film may discolour or lose elasticity and grow brittle, resulting in premature breaking of the pouch or packet and release of the contents prior to use.

Polyvinyl alcohol (PVOH) is one such water-soluble polymer that is commonly used to form unit dose packages, as PVOH films exhibit good strength, impact resistance, and are soluble in water. The solubility of PVOH films, however, rapidly decreases when exposed to certain reactive chemicals, such as acids, oxidants, bases, bleaches, etc.

Thus, in applications which employ these types of chemicals, the use of PVOH packaging is restricted, as the effective shelf-life of the unit dose products is limited by their solubility in water.

This is a particular problem in the case of packaging of reactive acids, especially those containing more than one carboxylic acid group such as citric acid. Citric acid is an attractive active in many cleaning products, e.g. machine descalers and acidic hard surface cleaners. However, such acids react with polyol films, such as PVOH, particularly at high temperatures and humidity, crosslinking them and leading to their water insolubility.

Attempts have been made to mitigate the above problems. US Patent Application—US 2014/0110301 A1 describes the use of a polymer film comprising a PVOH copolymer containing vinyl alcohol, vinyl ester, and pyrrolidone monomers for improving water solubility, biodegradability, and physical properties of PVOH films when in contact with harsh, oxidising chemicals.

International Patent Application—WO 2021/067482 A1 describes the use of a polymer film comprising a water-soluble mixture of PVOH and a polyvinylpyrrolidone (PVP) to form soluble packaging for holding harsh chemical compositions.

Whilst such approaches have seen some success at improving the compatibility of PVOH films with reactive chemicals, they also suffer from several disadvantages. Firstly, in such methods, the high loadings of the overall PVOH films necessitate the use of high loadings of additional polymers (such as PVP) to improve reactive chemical compatibility.

Furthermore, research has shown that the PVP/PVOH system (used in the above approaches) can still be crosslinked by reactive chemicals such as citric acid (S. Thongsuksaengcharoen et al, ACS Omega 2020, 5, 25973-25983).

Given the above, there remains a need for water-soluble polymer films, particularly PVOH films, that ameliorate these and/or other disadvantages of the prior art.

It is an aim of embodiments of the present invention to address one or more of the above problems by providing a water-soluble polymer film, which offers one or more of the following advantages:
Ability to be used in packaging for holding reactive chemicals (such as acids, oxidants, bases, bleaches, aldehydes etc.—and especially acids containing more than one carboxylic acid group, such as citric acid) whilst also maintaining good solubility, elasticity, and/or resistance to discolouration.
Substantial inertness to cross-linking with reactive chemicals, particularly acids containing more than one carboxylic acid group.
Physical and chemical properties and/or aesthetics of the film not adversely affected after long storage times at high temperature/humidity with or without a reactive chemical.
Ability to dissolve readily in water, preferably even in cold water.
Ability to retain the optical transparency of unmodified water-soluble polymer films.
Good sealability with other polymer films.
Straightforward production. Preferably producible using standard processes and equipment.
Ability to be used to package chemicals without adversely affecting their performance.
Improved handling.

It is also an aim of embodiments of the present invention to overcome or mitigate at least one problem of the prior art, whether expressly disclosed herein or not.

### SUMMARY OF THE INVENTION

According to a first aspect of the invention, there is provided a coated water-soluble film comprising a water-soluble polymer base film and a coating comprising at least one amphiphilic polymer.

Such a polymer film comprising at least one amphiphilic polymer coating displays inertness upon contact with reactive chemicals, and in particular solid acids containing more than one carboxylic acid group, such as citric acid. The coated films display such inertness even on prolonged exposure to the reactive chemicals at high temperature/humidity. Without intending to be bound by theory, it is believed that the amphiphilic polymer coating forms a physical barrier layer between the water-soluble base film and the contacting reactive chemical, which avoids unwanted reactions, such as crosslinking reactions, between the film and reactive chemical. Furthermore, the physical and chemical properties and aesthetics of the film are not adversely affected—the films maintain good water solubility (even in cold water), elasticity and flexibility, and minimally discolour. Such a coated film also advantageously retains the optical transparency of unmodified water-soluble polymer films.

In some embodiments, the water-soluble polymer base film comprises at least one polymer with a nucleophilic group, which may be part of a side chain. The nucleophilic group may comprise a functional group such as an alcohol group, a phenol group, an amine group, a thiol group, and derivatives, anions, or combinations thereof. In preferred embodiments, the water-soluble polymer base film comprises a polyalcohol, most preferably polyvinyl alcohol (PVOH) or a derivative or copolymer thereof.

The PVOH of the base film may be partially or fully alcoholised or hydrolysed. The PVOH of the base film may be an at least 10% alcoholised or hydrolysed polyvinyl acetate film, or an at least 20, 30, 40, 50, 60, 70, 80, 90, or an at least 95% alcoholised or hydrolysed polyvinyl acetate film. The PVOH of the base film may be a substantially fully alcoholised or hydrolysed base film. The PVOH of the base film may be a no greater than 98% alcoholised or hydrolysed polyvinyl acetate film, or a no greater than 96, 94, 92, 90, 88, 86, 84, 82, or a no greater than 80% alcoholised or hydrolysed base film. The PVOH of the base film may be an alcoholised or hydrolysed polyvinyl acetate film, wherein said film is alcoholised or hydrolysed in a range of 40 to 100%, preferably of 65 to 99.99%, more preferably of 72 to 92%, and most preferably of 80 to 90%. The degree of hydrolysis is known to influence the temperature at which the PVOH base film starts to dissolve in water. 88% hydrolysis corresponds to a base film soluble in cold (i.e. room temperature) water, whereas 92% hydrolysis corresponds to a film soluble in warm water, for example.

The PVOH base film may be a thermoformed PVOH film.

In some embodiments, the base film comprises PVOH or a derivative thereof in an amount of at least 50 wt % of the base film, or of at least 55, 60, 65, 70, 75, 80, 85, 90, or of at least 95 wt % of the base film. In some preferred embodiments, the base film is made entirely of PVOH or a derivative thereof. In a preferred embodiment, the base film comprises PVOH or a derivative thereof in an amount of ranging from 70 to 85 wt % of the base film.

The base film may be cast, blown or extruded. It may further be unoriented, mono-axially oriented or bi-axially oriented.

In some embodiments, the base film has a thickness of at least 10 μm, or of at least 20, 30, 40, 50, 60, or of at least 70 μm, or preferably of at least 80 μm, or of at least 90 μm. The base film may have a thickness of no greater than 200 μm, or of no greater than 175, 150, 125, or of no greater than 100 μm. In some embodiments, the base film may have a thickness of between 20-160 μm, or of between 30-150 μm, or of between 40-140 μm, or of between 50-130 μm, or of between 55-120 μm, or of between 60-110 μm, or preferably of between 65-100 μm, or of between 70-95 μm. In some embodiments, the base film is at least 50% transparent, or at least 60, 70, 80, or at least 90% transparent. In some embodiments, the base film is substantially fully transparent.

In some embodiments, the coating is present on a surface of the base film. The coating may preferably be present as a layer on the surface of the base film. In some embodiments, the coating is substantially separate from the surface of the base film. The coating may be bonded to the surface of the base film. The coating may be bonded to the surface of the base film via covalent bonds, ionic bonds, hydrogen bonds, or Van der Waals forces. At least one amphiphilic polymer of the coating may be bonded to the surface of the base film via one or more surface linker groups which may be present on the amphiphilic polymer, the base film surface, or both. In some embodiments, the coating may be melded with or physically entangled with the base film.

In some embodiments, the coating is present on at least 10% of the surface area of the base film, or on at least 20, 30, 40, 50, 60, 70, or on at least 80% of the surface area of the base film. In some preferred embodiments, the coating is present on at least 85% of the surface area of the base film, or on at least 90, or on at least 95% of the surface area of the base film, or on substantially 100% of the surface area of the base film. The coating may be present on no greater than 98% of the surface area of the base film, or on no greater than 96, 94, 92, 90, 88, 86, 84, 82, or on no greater than 80% of the surface area of the base film. The coating may be present on between 10-100% of the surface area of the base film, or on between 40-100%, or on between 60-100%, or on between 80-100% of the surface area of the base film.

In some embodiments, the base film may be in the form of a sheet with two faces. In such embodiments, the coating may be present on both faces of the base film sheet. In preferred embodiments, the coating may be present on only one face of the base film sheet, preferably the face which may contact a reactive chemical, in use. In such embodiments, statements above relating to the % of the base film surface area on which the coating is present may be used to refer to the surface area of one face of the base film or of both faces of the base film. In such embodiments, other statements in this specification relating to the base film surface may relate only to the surface of one face of the base film sheet or may relate to the surface of both faces of the base film sheet.

In some embodiments, the coating is uniformly distributed on the surface of the base film. In other embodiments, the coating is non-uniformly distributed on the surface of the base film. The coating may, for example, be more concentrated on parts of the surface of the base film which may, in use, be in closer contact with a reactive chemical or which may be in contact with a reactive chemical for longer, than other parts of the surface.

In some embodiments, the coating may be present on the surface of the base film or a part thereof at a loading of at least 0.05 mg/cm², or of at least 0.1, 0.2, 0.3, 0.4, 0.5, 0.6, 0.7, 0.8, 0.9, or of at least 1 mg/cm². In some embodiments, the coating may be present on the surface of the base film or a part thereof at a loading of no greater than 10 mg/cm², or of no greater than 9, 8, 7, 6, 5, 4, 3, or of no greater than 2 mg/cm². The coating may be present on the surface of the base film or a part thereof at a loading of between 0.05-10 mg/cm², or of between 0.1-8 mg/cm², or preferably of between 0.2-6 mg/cm², or more preferably of between 0.3-4 mg/cm², or of between 0.4-3 mg/cm², or preferably of between 0.5-2 mg/cm², or of between 0.7-1.7 mg/cm², or most preferably of between 0.8-1.4 mg/cm². In such embodiments, the coating is preferably uniformly distributed on the surface of the base film or said part thereof.

In some embodiments, the coating is present in an amount of at least 0.5 wt % of the coated film. In some embodiments, the coating is present in an amount of no greater than 10 wt % of the coated film, or of no greater than 8, 6, 4, 2, or of no greater than 1 wt % of the coated film. The coating may be present in an amount of between 0.05-40 wt % of the coated film, or of between 1-35 wt %, or of between 1-30 wt %, or of between 1-25 wt %, or of between 2-20 wt %, or of between 3-17 wt %, or of between 4-15 wt %, or of between 5-12 wt %, or of between 6-10 wt % of the coated film.

In some embodiments, the coating comprises a layer with a thickness of at least 0.2 μm, or of at least 0.4, 0.6, 0.8, or of at least 1 μm, or of at least 2, 3, 4, 5, 6, 7, 8, 9, or of at least 10 μm. In some embodiments, the coating comprises a layer with a thickness of no greater than 60 μm, or of no greater than 55, 50, 45, or preferably of no greater than 40, 35, 30, 25, or of no greater than 20 μm. The coating may comprise a layer with a thickness of between 0.2-60 μm, or of between 0.5-50 μm, or of between 1-40 μm, or of between 1-30 μm, or of between 1-20 μm, or of between 5-20 μm, or of between 5-15 μm.

In some embodiments, the coating has an amphiphilic polymer concentration of at least 10 wt % of the coating, or of at least 20, 30, 40, 50, 60, 70, 80, 90 or of at least 95 wt % of the coating. The coating may have an amphiphilic polymer concentration of substantially 100 wt % of the coating. The coating may have an amphiphilic polymer concentration of no greater than 98 wt % of the coating, or of no greater than 96, 94, 92, 90, 88, 86, 84, 82, or of no greater than 80 wt % of the coating.

In preferred embodiments, the amphiphilic polymer(s) of the coating and/or substantially the whole coating is soluble in a non-solvent of PVOH, preferably in an organic solvent. Suitable organic solvents include alcohols. The alcohol may comprise a primary, secondary, or tertiary alcohol; and preferably a primary alcohol. The alcohol may be methanol, ethanol, propanol, butanol, pentanol, hexanol, heptanol, octanol, decanol, and isomers, derivatives or combinations thereof. In a particularly preferred embodiment, the alcohol is ethanol. In particularly preferred embodiments, the amphiphilic polymer(s) of the coating and/or substantially the whole coating is soluble in a non-solvent of PVOH and also soluble in water. The amphiphilic polymer(s) of the coating and/or substantially the whole coating may be soluble in the alcohol, preferably ethanol, and may also be soluble in water.

In some embodiments, the coating comprises a non-hydroxyl functionalised polymer. In some embodiments, the coating comprises less than 10 wt % of a hydroxyl functionalised polymer, or less than 9, 8, 7, 6, 5, 4, 3, 2, or less than 1 wt % of a hydroxyl functionalised polymer. The coating may comprise substantially no hydroxyl functionalised polymer. The coating may comprise substantially no PVOH.

In preferred embodiments, the coating comprises at least one amphiphilic copolymer. the amphiphilic copolymer may comprise hydrophilic and hydrophobic monomer units. At least one amphiphilic copolymer may comprise a block, random, alternate, periodic, and/or graft copolymer. In embodiments wherein at least one amphiphilic copolymer comprises a block copolymer, the amphiphilic copolymer may comprise a di-, tri-, tetra-, or penta-block copolymer.

In preferred embodiments, the coating comprises at least one amphiphilic copolymer comprising at least one hydrophilic monomer and at least one hydrophobic monomer. At least one hydrophilic monomer may be an acidic monomer, an anionic monomer, or combinations thereof.

The coating may preferably comprise at least one amphiphilic copolymer comprising at least one acidic/anionic monomer. At least one acidic/anionic monomer may preferably comprise a vinyl anionic/acidic monomer. At least one acidic/anionic monomer may comprise a carboxylic acid containing vinyl monomer or any salt or derivative thereof. The carboxylic acid containing vinyl monomer may comprise a monocarboxylic acid vinyl monomer and/or a dicarboxylic acid vinyl monomer. In some preferred embodiments, at least one acidic/anionic monomer is an acrylic acid or alkacrylic acid monomer, a methacrylic acid monomer or salts thereof, a crotonate monomer, a maleic acid monomer or monoester derivative thereof, a fumaric acid monomer or monoester derivative thereof, an itaconic acid monomer or monoester derivative thereof, a citraconic acid monomer or monoester derivative thereof, a mesaconic acid monomer or monoester derivative thereof, a glutaconic acid monomer or monoester derivative thereof, and any salts, derivatives, or combinations thereof. In some embodiments, at least one acidic/anionic monomer comprises a vinyl sulfonic acid monomer or a salt or derivative thereof. The vinyl sulfonic acid monomer may be 2-acrylamido-1-methylpropanesulfonic acid, 2-acrylamide-2-methylpropanesulfonic acid (AMPS), 2-methylacrylamido-2-methylpropanesulfonic acid, 2-sulfoethyl acrylate, or any salts, derivatives, or combinations thereof. In particularly preferred embodiments, at least one acidic/anionic monomer is an acrylic acid or alkacrylic acid monomer, a methacrylic acid monomer or salts thereof, a crotonate monomer, a maleic acid monomer or monoester derivative thereof, or any salts, derivatives, or combinations thereof. In some preferred embodiments, at least one acidic/anionic monomer is acrylic acid; a methacrylic acid monomer or salts thereof, crotonic acid; maleic acid or a C1-C10 monoester thereof, preferably maleic acid butyl monoester; or any salts, derivatives, or combinations thereof.

In some embodiments, the coating comprises at least one amphiphilic copolymer comprising at least one vinyl hydrophobic monomer. In some embodiments, at least one hydrophobic monomer is an alkylene, a styrene, a vinyl chloride, a fluoroethene, an acrylonitrile, an alkyl acrylamide monomer, an alkyl acrylate monomer, an alkyl alkacrylate monomer, an alkylaminoalkyl acrylate monomer, an alkylaminoalkyl alkacrylate monomer, a vinyl alkanoate monomer, a vinyl alkyl ether monomer or monoester derivative thereof, a vinylpyrrolidone monomer or derivative thereof, an alkylene glycol alkacrylate, or any salts, derivatives or combinations thereof. In preferred embodiments, at least one hydrophobic monomer is an alkyl acrylamide monomer, an alkyl acrylate monomer, an alkyl alkacrylate monomer, an alkylaminoalkyl acrylate monomer, an alkylaminoalkyl alkacrylate monomer, a vinyl alkanoate monomer, a vinyl alkyl ether monomer or monoester derivative thereof, a vinylpyrrolidone monomer or derivative thereof, an alkylene glycol alkacrylate, or any salts, derivatives or combinations thereof. In some preferred embodiments, at least one hydrophobic monomer comprises a side chain containing a bulky group, preferably a branched alkyl group, and most preferably a t-butyl group. In some preferred embodiments, at least one hydrophobic monomer is an octylacrylamide monomer, preferably tertoctylacrylamide; a butylaminoethyl methacrylate monomer, preferably tertbutylaminoethylmethacrylate; a methyl methacrylate monomer; an alkylene glycol methacrylate monomer, preferably propylene glycol methacrylate; a vinyl neodecanoate monomer; a vinyl acetate monomer; a t-butylacrylamide monomer; an ethyl acrylate monomer; a vinyl methyl ether monomer or monoester derivative thereof, preferably vinyl methyl ether butyl monoester; or any salts, derivatives or combinations thereof.

The at least one amphiphilic copolymer of the coating may comprise at least two different monomers, and preferably at least three different monomers. In some preferred embodiments, at least one amphiphilic polymer comprises only one hydrophilic monomer and at least two different hydrophobic monomers.

In some preferred embodiments, at least one amphiphilic copolymer of the coating comprises an acrylic acid monomer or salt or derivative thereof; and further comprises at least one hydrophobic monomer being an alkyl acrylamide monomer, an alkyl acrylate monomer, an alkyl alkacrylate monomer, an alkylaminoalkyl acrylate monomer, an alkylaminoalkyl alkacrylate monomer, a vinyl alkanoate monomer, a vinyl alkyl ether monomer or monoester derivative thereof, a vinylpyrrolidone monomer or derivative thereof, an alkylene glycol alkacrylate, or any salts, derivatives or combinations thereof.

At least one amphiphilic copolymer of the coating may preferably comprise an acrylic acid monomer or salt or derivative thereof; and may further comprise at least one, preferably two, hydrophobic monomers being an alkylaminoalkyl alkacrylate, preferably an alkylaminoalkyl methacrylate monomer; an alkyl acrylamide monomer; an alkyl acrylate monomer; an alkyl alkacrylate, preferably an alkyl methacrylate monomer; a vinyl alkanoate monomer; an alkylene glycol alkacrylate, preferably an alkylene glycol methacrylate monomer; or any salts, derivatives or combinations thereof.

At least one amphiphilic copolymer of the coating may preferably comprise an acrylic acid monomer or salt or derivative thereof; and may further comprise at least one, preferably two, hydrophobic monomers being an octylacrylamide monomer, preferably tertoctylacrylamide; a butylaminoethyl methacrylate monomer, preferably tertbutylaminoethylmethacrylate; a methyl methacrylate monomer; an alkylene glycol methacrylate monomer, preferably propylene glycol methacrylate; a t-butylacrylamide monomer; an ethyl acrylate monomer; and any salts, derivatives and combinations thereof.

In a particularly preferred embodiment, at least one amphiphilic copolymer of the coating comprises an acrylic acid monomer or salt or derivative thereof; and further comprises at least one, preferably two, hydrophobic monomers being an octylacrylamide monomer, preferably tertoctylacrylamide; a butylaminoethyl methacrylate monomer, preferably tertbutylaminoethylmethacrylate; or any salts, derivatives or combinations thereof. In this particular embodiment, the amphiphilic copolymer may optionally further comprise at least one, or two, hydrophobic monomers being a methyl methacrylate monomer; an alkylene glycol methacrylate monomer, preferably propylene glycol methacrylate; or any salts, derivatives or combinations thereof.

In another particularly preferred embodiment, at least one amphiphilic copolymer of the coating comprises an acrylic acid monomer or salt or derivative thereof; and further comprises at least one, preferably two, hydrophobic monomers being a t-butylacrylamide monomer; an ethyl acrylate monomer; or any salts, derivatives or combinations thereof.

In some preferred embodiments, at least one amphiphilic copolymer of the coating comprises a crotonic acid monomer or salt or derivative thereof; and further comprises at least one hydrophobic monomer being an alkyl acrylamide monomer, an alkyl acrylate monomer, an alkyl alkacrylate monomer, an alkylaminoalkyl acrylate monomer, an alkylaminoalkyl alkacrylate monomer, a vinyl alkanoate monomer, a vinyl alkyl ether monomer or monoester derivative thereof, a vinylpyrrolidone monomer or derivative thereof, an alkylene glycol alkacrylate, or any salts, derivatives or combinations thereof.

At least one amphiphilic copolymer of the coating may preferably comprise a crotonic acid monomer or salt or derivative thereof; and may further comprise at least one, preferably two, hydrophobic vinyl alkanoate monomers, or any salts or derivatives thereof.

In a particularly preferred embodiment, at least one amphiphilic copolymer of the coating comprises a crotonic acid monomer or salt or derivative thereof; and further comprises at least one, preferably two, hydrophobic monomers being a vinyl neodecanoate monomer, a vinyl acetate monomer, or any salts, derivatives or combinations thereof.

In some preferred embodiments, at least one amphiphilic copolymer of the coating comprises: a maleic acid monomer; a C1-C10 monoester thereof, preferably maleic acid butyl monoester; or a salt or derivative thereof; and the amphiphilic copolymer further comprises at least one hydrophobic monomer being an alkyl acrylamide monomer, an alkyl acrylate monomer, an alkyl alkacrylate monomer, an alkylaminoalkyl acrylate monomer, an alkylaminoalkyl alkacrylate monomer, a vinyl alkanoate monomer, a vinyl alkyl ether monomer or monoester derivative thereof, a vinylpyrrolidone monomer or derivative thereof, an alkylene glycol alkacrylate, or any salts, derivatives or combinations thereof.

In a particularly preferred embodiment, at least one amphiphilic copolymer of the coating comprises: a maleic acid monomer; a C1-C10 monoester thereof, preferably maleic acid butyl monoester; or a salt or derivative thereof; and the amphiphilic copolymer further comprises at least one vinyl alkyl ether hydrophobic monomer or monoester derivative thereof, or any salt or derivative thereof. The vinyl alkyl ether hydrophobic monomer or monoester derivative thereof preferably comprises vinyl methyl ether or vinyl methyl ether butyl monoester.

In some embodiments, the coated water-soluble film is at least 50% as transparent as the uncoated base film, or at least 60, 70, 80, 90, or at least 95% as transparent as the uncoated base film. In some embodiments, the coated water-soluble film is as transparent as the uncoated base film. In some embodiments, the coated water-soluble base film is more transparent than the uncoated base film.

In some embodiments, the coated water-soluble film optionally comprises one or more additional ingredients such as surfactants, colourants, plasticizers, antioxidants, acid scavengers, fillers, defoamers, and combinations thereof.

The coated water-soluble film may comprise any suitable plasticizer. A plasticizer is a liquid, solid, or semi-solid that is added to a material making that material softer, more flexible (by decreasing the glass-transition temperature of the polymer), or easier to process. The plasticizer may comprise but is not limited to one or more of the group comprising: glycerol, diglycerin, sorbitol, ethylene glycol, diethylene glycol, triethylene glycol, dipropylene glycol, tetraethylene glycol, propylene glycol, polyethylene glycols up to 400 Da molecular weight, hexylene glycol, neopentyl glycol, trimethylolpropane, polyether polyols, polyether diol, polyether triol, xylitol, 2-methyl-1,3-propanediol (MPDiol®), ethanolamines, glycerol propylene oxide polymers (such as, for example, Voranol™ available from The Dow Chemical Company), or combinations thereof.

In embodiments wherein the coated water-soluble film comprises a plasticizer, the plasticizer may be provided in an amount of about 1 wt. % to about 45 wt. %, or about 5 wt. % to about 35 wt. %, or about 7.5 wt. % to about 30 wt. %, or about 8 wt. % to about 20 wt. %, or about 8 wt % to about 12 wt %, based on the weight of the coated film.

The coated water-soluble film may comprise any suitable acid scavenger. The acid scavenger may comprise but is not limited to one or more of the groups comprising: N-vinyl pyrrolidone, sodium metabisulfite, activated olefins, maleate molecules (e.g., maleic acid and its derivatives), allylic compounds (e.g., allylic alcohols, allylic acetates, etc.), ethylene containing compounds, quaternary ammonium compounds, amines (e.g., pyridine, monoethanolamine, methylamine, aniline), tertiary amine containing compounds, and combinations thereof.

The coated water-soluble film may comprise any suitable antioxidant and/or chlorine scavenger. The antioxidant/chlorine scavenger may comprise but is not limited to one or more of the group comprising: sulfite, bisulfite, thiosulfate, thiosulfite, iodide, nitrite, carbamate, ascorbate, propyl gallate, gallic acid, citric acid, sodium metabisulfite, carbamate, phenolic compounds, hindered amines, zinc acetate, sulfate, bisulfate, carbonate, bicarbonate, nitrate, chloride, borate, phosphate, condensed phosphate, acetate, benzoate, citrate, formate, lactate, salicylate, and combinations thereof. The antioxidant/chlorine scavenger may be present in an amount of between 0.25 wt %- 5 wt %, or between 0.5 wt %- 2.5 wt %, or between 1 wt %- 2 wt %.

The coated water-soluble film can further contain other auxiliary agents and processing agents, such as, but not limited to, surfactants, lubricants, release agents, fillers, extenders, cross-linking agents, antiblocking agents, detackifying agents, antifoams (defoamers), nanoparticles such as layered silicate-type nanoclays (e.g., sodium montmorillonite), bleaching agents (e.g., sodium metabisulfite, sodium bisulfate (SBS) or others), aversive agents such as bitterants (e.g., denatonium salts such as denatonium benzoate, denatonium saccharide, and denatonium chloride; sucrose octaacetate; quinine; flavonoids such as quercetin and naringen; and quassinoids such as quassin and brucine) and pungents (e.g., capsaicin, piperine, allyl isothiocyanate, and resinferatoxin), and other functional ingredients, in amounts suitable for their intended purposes.

The coated water-soluble film may comprise any suitable surfactant. The surfactant may comprise but is not limited to one or more of the group comprising: dialkyl sulfosuccinates, lactylated fatty acid esters of glycerol and propylene glycol, lactylic esters of fatty acids, sodium alkyl sulfates, polysorbate 20, polysorbate 60, polysorbate 65, polysorbate 80, alkyl polyethylene glycol ethers, lecithin, acetylated fatty acid esters of glycerol and propylene glycol, sodium lauryl sulfate, acetylated esters of fatty acids, myristyl dimethylamine oxide, trimethyl tallow alkyl ammonium chloride, quaternary ammonium compounds, and salts or combinations thereof.

The coated water-soluble film may comprise any suitable defoamer. The defoamer may comprise but is not limited to one or more of the group comprising: hydrophobic silicas, for example silicon dioxide or fumed silica in fine particle sizes, including Foam Blast® defoamers available from Emerald Performance Materials, including Foam Blast® 327, Foam Blast® UVD, Foam Blast® 163, Foam Blast® 269, Foam Blast® 338, Foam Blast® 290, Foam Blast® 332, Foam Blast® 349, Foam Blast® 550, Foam Blast® 339, and combinations thereof.

Suitable fillers/extenders/antiblocking agents/detackifying agents for use in the coated water-soluble film include, but are not limited to, one or more of the groups comprising: starches, modified starches, crosslinked polyvinylpyrrolidone, crosslinked cellulose, microcrystalline cellulose, silica, metallic oxides, calcium carbonate, talc, mica, stearic acid, and salts or combinations thereof. In some embodiments, the amount of filler/extender/antiblocking agent/detackifying agent in the coated water-soluble film may be in a range of about 0 wt % to about 10 wt %, or about 0 wt. % to about 8 wt. %, or about 0 wt. % to about 7.5 wt. %, for example.

The coated water-soluble film may comprise one or more further water-soluble polymers including, but not limited to one or more of the groups comprising: polyvinyl alcohols, water-soluble acrylate copolymers, polyethyleneimine, pullulan, water-soluble natural polymers including, but not limited to, guar gum, gum Acacia, xanthan gum, carrageenan, and starch, water-soluble polymer modified starches, and copolymers, blends, or combinations thereof. Further water-soluble polymers may be selected from the group comprising: polyalkylene oxides, polyacrylamides, celluloses, cellulose ethers, cellulose esters, cellulose amides, polyvinyl acetates, polycarboxylic acids and salts thereof, polyaminoacids, polyamides, gelatines, methylcelluloses, carboxymethylcelluloses and salts thereof, dextrins, ethylcelluloses, hydroxyethyl celluloses, hydroxypropyl methylcelluloses, maltodextrins, polymethacrylates, and copolymers, blends, or combinations thereof.

According to a second aspect of the invention, there is provided a water-soluble unit dose article comprising a composition packaged in a container comprising the coated water-soluble film of the first aspect of the invention.

Statements of invention above relating to the coated water-soluble film of the first aspect of the invention may also be applied to the second aspect of the invention.

Where reference is made in the second aspect of the invention to any components of the coated water-soluble film referenced previously in the first aspect of the invention, statements of invention relating to the components for the first aspect of the invention may equally apply.

In some embodiments, the composition comprises a reactive chemical such as an acid, an oxidant, a base, a bleach, an aldehyde, or combinations thereof.

The composition may comprise at least one oxidant such as a hypochlorite, a halogenated isocyanurate, a chlorate, a chlorite, a perchlorate, a bromate, a perbromate, a halogenated hydantoin, a borate, a perborate, a periodate, a persulfate, a permanganate, a chromate, a dichromate, a nitrate, a nitrite, a peroxide, a ketone peroxide, a peroxy acid, a superoxide, a halogen (such as bromine, chlorine, iodine, and fluorine), an inorganic acid, or any salts, hydrates, or combinations thereof. In some embodiments, the oxidant comprises one or more of the groups comprising: trichloroisocyanuric acid, triisocyanuric acid, diisocyanuric acid, 1-bromo-3-chloro-5,5-dimethylhydantoin, calcium hypochlorite, potassium peroxymonosulfate, and any salts, hydrates, or combinations thereof.

In some embodiments, the composition comprises at least one base. The base may be a hydroxide, carbonate, oxide, bicarbonate, amine or ammonia, or any salts, derivatives, or combinations thereof.

In preferred embodiments, the composition comprises at least one acid reactive chemical. In some embodiments, the composition comprises an inorganic acid. The inorganic acid may be a hydrogen halide, a halogen oxoacid, sulfuric acid, nitric acid, phosphoric acid, boric acid, or any derivatives, or combinations thereof. The acid reactive chemical may preferably comprise a solid acid. The acid reactive chemical may preferably comprise an organic acid. The acid reactive chemical may comprise a carboxylic acid group, preferably more than one carboxylic acid group. In preferred embodiments, the acid reactive chemical may be citric acid, gluconic acid, hydroxyacetic acid, levulinic acid, oxalic acid, acetic acid, tartaric acid, or any salts, derivatives, or combinations thereof. In a particularly preferred embodiment, the composition comprises citric acid, and preferably solid citric acid.

The composition may be a solid, liquid, or combination thereof. “Liquid” may include free-flowing liquids, as well as pastes, gels, foams, and mousses. Gases, such as suspended bubbles, or solids, such as particles, may be included within the liquids. A “solid” may include, but is not limited to, powders, agglomerates, granules, micro-capsules, beads, tablets, noodles, and balls. In preferred embodiments, the composition comprises at least one solid reactive chemical. Preferably, the whole composition may be solid.

In some embodiments, the reactive chemical is present in an amount of at least 0.5 wt % of the composition, or at least 1, 2, 3, 4, 5, 10, 20, 30, 40, 50, 60, 70, 80, 90, or at least 95 wt % of the composition. The composition may, in some embodiments, consist entirely of the reactive chemical. In some embodiments, the reactive chemical is present in an amount of no greater than 98 wt % of the composition, or no greater than 96, 94, 92, 90, 88, 86, 84, 82, or no greater than 80 wt % of the composition.

In some embodiments, the composition is present in an amount of at least 5 wt % of the water-soluble unit dose article, or at least 10, 20, 30, 40, 50, 60, 70, 80, 90, or at least 95 wt % of the water-soluble unit dose article. In some embodiments, the composition is present in an amount of no greater than 98 wt % of the water-soluble unit dose article, or no greater than 96, 94, 92, 90, 88, 86, 84, 82, or no greater than 80 wt % of the water-soluble unit dose article.

In some embodiments, the coated water-soluble film is in direct contact with the composition or at least a part thereof. Said part preferably comprises at least one reactive chemical. In embodiments wherein the water-soluble film is only partially coated with at least one amphiphilic polymer, uncoated parts of the film are preferably not in direct contact with the composition or at least not in direct contact with parts of the composition comprising at least one reactive chemical.

In some embodiments, the container comprises the coated water-soluble film as a sheet. The sheet may have two faces. Both faces of the sheet may comprise the amphiphilic polymer coating. In preferred embodiments, only one face of the sheet may comprise the amphiphilic polymer coating and only said face may contact the composition, in use. In some embodiments, the container comprises a single sheet of coated water-soluble film that is folded over itself and sealed at its edges to define an internal cavity in which the composition is contained.

In some embodiments, the container comprises more than one water-soluble film, wherein at least one film is coated. The container may comprise two water-soluble films, preferably in sheet form. Only one or both of the films may be coated. Only one or both faces of the sheet or sheets may comprise the amphiphilic polymer coating. In some embodiments, both films are coated, preferably only on the faces of the sheets which may contact the composition, in use. In a preferred embodiment, the container comprises two water-soluble films sealed together to define an internal cavity in which the composition is contained. In such an embodiment, parts of the films facing the composition contained in the internal cavity are preferably coated with at least one amphiphilic polymer. Parts of the films not facing the composition contained in the internal cavity may not be coated.

The container may be a sachet, bag, pouch, packet etc. In some embodiments, the container is a multi-compartment container. The multi-compartment container may comprise two or more, three or more, four or more, five or more, or six or more separated compartments. Each of the compartments may be arranged side-by-side, concentrically, as sectors of a circle or in any suitable random or organised pattern. The container may comprise a first water-soluble film comprising a pocket and a surrounding flange, and a second water-soluble film, applied as a cover across the pocket and sealed across the flange. The container may comprise a first water-soluble film comprising more than one pocket, for example two or more, three or more, four or more, five or more, or six or more pockets, and a surrounding flange, and a second water-soluble film, applied as a cover across each pocket and sealed across the flange. In some embodiments there are three or four pockets.

In some embodiments, the coated water-soluble film of the invention makes up at least 5 wt % of the container, or at least 10, 20, 30, 40, 50, 60, 70, 80, 90, or at least 95 wt % of the container. In some embodiments, the coated water-soluble film of the invention makes up substantially the entirety of the container.

In some embodiments, the container has an average largest dimension of at least 0.1 cm, or at least 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, or at least 10 cm. The container may have an average largest dimension of no greater than 100 cm, or no greater than 90, 80, 70, 60, or no greater than 50 cm. The container may have an average largest dimension of between 1-80 cm, or of between 2-60 cm, or of between 4-40 cm, or between 5-30 cm.

The container may define an internal cavity in which the composition is contained, in use. The internal cavity may define a volume of at least 1 mL, or of at least 2, 3, 4, 5, 10, 15, 20, 25, 30, 35, 40, 45, or of at least 50 mL. The internal cavity may define a volume of no greater than 5 L, or of no greater than 4.5, 4, 3.5, 3, 2.5, 2, 1.5, or of no greater than 1 L. The internal cavity may define a volume of between 1-1000 mL, or of between 5-800 mL, or of between 5-500 mL, or of between 5-400 mL, or between 5-300 mL, or between 5-200 mL, or of between 5-150 mL, or of between 5-100 mL, or of between 5-75 mL, or between 5-50 mL, or between 5-25 mL.

In some embodiments, the water-soluble unit dose article is a cleaning product. The water-soluble unit dose article may be, but is not limited to, a hard surface cleaner (preferably an acidic hard surface cleaner), a descaler, a dishwashing machine cleaner, a toilet cleaner, a household care composition, or a multi-purpose cleaner. The water-soluble unit dose article may be a household product or an industrial product. The water-soluble unit dose article may be a refill cleaning product. The water-soluble unit dose article may be diluted with water before use to release the contained composition from the container. The inventive water-soluble unit dose articles of the invention may find particular application when it is necessary to use the composition in a particular dosage amount, which is then diluted before use.

The water-soluble unit dose article may have a shelf life of at least 3 weeks, or at least 4, 5, 6, 7, 8, 9, or at least 10 weeks. The water-soluble unit dose article may have a shelf life of at least several months, or at least a year, or greater than a year, or several years.

According to a third aspect of the invention, there is provided the use of the water-soluble unit dose article of the second aspect of the invention as a hard surface cleaner, a descaler, a toilet cleaner, a dishwashing machine cleaner, a household care composition, or a multi-purpose cleaner.

Statements of invention above relating to the water-soluble unit dose article of the second aspect of the invention or to any of its components may also be applied to the third aspect of the invention.

In some embodiments, the water-soluble unit dose article is diluted with water before use. This preferably dissolves at least a portion of the coated water-soluble film and releases the contained composition from the container and to the water. The composition may comprise or be a solid. The composition may dissolve in the water to produce a treatment composition. The treatment composition may be applied to a hard surface to clean the hard surface.

Many known hard surface cleaners contain large amounts of water, which unnecessarily increases the CO₂ footprint during transport. The present invention allows for solid cleaners to be provided which can simply be diluted with water before use.

The hard surface cleaner or descaler may be used on one or more surfaces comprising metal surfaces, glass surfaces, ceramic surfaces, wood surfaces, plastic surfaces, and surfaces containing more than one material type.

In embodiments wherein the water-soluble unit dose article is used as a dishwashing machine cleaner, the unit dose article may be added to the machine during a dummy washing or rinsing cycle in which the dishwasher is substantially free of dishware. In other embodiments, the unit dose article may be added to the machine during a normal washing or rinsing cycle in which the dishwasher contains dishware for cleaning. The unit dose article may comprise a dishwashing machine cleaning composition at a dosage suitable for cleaning the dishwasher in a single application.

The water-soluble unit dose article functioning as a toilet cleaner may be added to a toilet bowl and the toilet may be flushed to clean the toilet bowl. The unit dose article may comprise a toilet cleaning composition at a dosage suitable for cleaning the toilet bowl in a single application.

According to a fourth aspect of the invention, there is provided a method of preparing the coated water-soluble film of the first aspect of the invention, the method comprising the steps of:
a. Providing a water-soluble polymer base film; and
b. Coating the base film with at least one amphiphilic polymer.

Statements of invention above relating to the coated water-soluble film of the first aspect of the invention or to any of its components may also be applied to the fourth aspect of the invention.

Where reference is made in the fourth aspect of the invention to any components of the coated water-soluble film referenced previously in the first aspect of the invention, statements of invention relating to the components for the first aspect of the invention may equally apply.

Step (a) may comprise preparing the water-soluble polymer base film using any suitable method. Suitable methods may include, but are not limited to: solution casting, film casting, wet process film formation, dry process film formation, film extrusion, melting film formation, coating process, and blown film methods, among others.

In some embodiments, step (a) comprises forming the base film by a solution casting method. The method may comprise preparing an aqueous solution of the base film components. The aqueous solution may then be spread out on a surface to a predetermined thickness. This step may comprise adding the aqueous solution to a forming belt and spreading it out to the predetermined thickness on the belt, preferably with a doctor blade. The aqueous solution may thereafter be heated, preferably in an oven, to reduce the moisture content (preferably to a moisture content of between 6-15%) and produce the base film.

In some embodiments, step (b) of the method comprises coating the base film with at least one amphiphilic polymer using a vapour deposition method, a chemical coating method, spray-coating, roll-to-roll coating, a physical coating method, or combinations thereof. Suitable vapour deposition coating methods may include but are not limited to: chemical vapour deposition methods, such as metalorganic vapour phase epitaxy, electrostatic spray assisted vapour deposition, and epitaxy. Suitable roll-to-roll coating methods may include but are not limited to: air knife coating, anilox coating, flexo coating, gap coating, knife-over-roll coating, gravure coating, hot melt coating, immersion dip coating, kiss coating, metering rod (Meyer bar) coating, roller coating (forward roller coating and reverse roll coating), silk screen coating, rotary screen coating, slot die coating, extrusion coating, curtain coating, slide coating, slot die bead coating, tensioned-web slot die coating, inkjet printing, lithography, and flexography. Suitable physical coating methods may include but are not limited to: Langmuir-Blodgett coating, spin coating, and dip coating.

In preferred embodiments, step (b) of the method comprises spray-coating the base film with at least one amphiphilic polymer. The spray coating method used for this step may be spray painting, thermal spraying, or combinations thereof. In some embodiments, step (b) comprises spray-coating the base film at a temperature of at least 10° C., or of at least 12, 14, 16, 18, 20, 22, or of at least 24° C. The method may comprise spray-coating the base film at a temperature of no greater than 200° C., or of no greater than 180, 160, 140, 120, 100, 80, 60, or of no greater than 40° C.

In preferred embodiments, step (b) of the method comprises dissolving at least one amphiphilic polymer in a solvent to form a solution, followed by spray-coating the base film with the solution. The solvent may preferably comprise a non-solvent of the base film, preferably a non-solvent of PVOH. The solvent may comprise an organic solvent, preferably an alcohol as described in the first aspect of the invention. In a particular embodiment, the solvent comprises ethanol. In some embodiments, the total amphiphilic polymer concentration of the solution is at least 0.01 wt %, or at least 0.02, 0.03, 0.04, 0.05, 0.06, 0.07, 0.08, 0.09, 0.1, 0.2, 0.3, 0.4, or at least 0.5 wt %. In some embodiments, the total amphiphilic polymer concentration of the solution is no greater than 50 wt %, or no greater than 45, 40, 35, 30, 25, 20, 15, or no greater than 10 wt %. The total amphiphilic polymer concentration of the solution may be between 0.01-50 wt %, or between 0.05-40 wt %, or preferably between 0.1-30 wt %, or between 0.2-20 wt %, or between 0.3-15 wt %, or most preferably between 1-5 wt %.

In some preferred embodiments, the method further comprises the step of neutralising the amphiphilic polymer solution before spray-coating the base film. The method may comprise neutralising the solution with at least one base, preferably with at least one amine base. The method may comprise neutralising the solution with at least one amine base being a primary amine, a secondary amine, a tertiary amine, or combinations thereof. The amine base may comprise one or more of the groups comprising: an aliphatic amine, an aromatic amine, a cyclic amine, and combinations thereof. In some embodiments, the amine base is an alkylamine, a dialkylamine, a trialkylamine, an aniline, a hydroxy-containing amine, a diamine, a polyamine, or combinations thereof. In preferred embodiments, the amine base is a hydroxy-containing amine, a diamine, or combinations thereof. Preferred specific bases may include but are not limited to one or more of the group comprising: 2-amino-2-methyl-1-propanol (AMP), N,N-Diethyl-1,3-diaminopropane, 1,1′,1″-Nitrilotri(propan-2-ol), 2-amino-2-methyl-1,3-propanediol, 1-Aminopropan-2-ol, N,N-Dimethyl-1-octadecanamine, 2-Aminoethan-1-ol, 3-(diethyleneamino)propylamine (DEPA), triisopropanolamine (TIPA), triethanolamine, and combinations thereof.

In some embodiments, the pKa value of the base in its protonated form is at least 4, or at least 4.5, 5, 5.5, 6, 6.5, 7, 7.5, or at least 8. The pKa value of the base in its protonated form may be no greater than 20, or no greater than 19, 18, 17, 16, 15, 14, 13, 12, or no greater than 11. The pKa value of the base in its protonated form may be between 4-20, or between 4-15, or between 5-14, or between 6-13, or between 7-12, or between 8-11.

In some embodiments, the method comprises the step of neutralising the amphiphilic polymer solution to a pH of at least 4, or of at least 4.5, 5, 5.5, 6, 6.5, 7, or to a pH of at least 7.5. The method may comprise the step of neutralising the amphiphilic polymer solution to a pH of no greater than 12, or no greater than 11.5, 11, 10.5, 10, 9.5, or to a pH of no greater than 9. The method may comprise the step of neutralising the amphiphilic polymer solution to a pH of between 4-12, or between 5-11, or preferably between 6-10, or between 7-9.5, or most preferably to a pH of between 7.5- 9. In some embodiments, the method comprises deprotonating at least 1% of the acidic hydrogen atoms in the or each amphiphilic polymer, or at least 2, 3, 4, 5, 10, 15, or preferably at least 20%, or at least 25, 30, 35, 40, 45, 50, 55, 60, 65, 70, 75, 80, 85, 90, or at least 95% of the acidic hydrogen atoms in the or each amphiphilic polymer. The method may comprise deprotonating substantially 100% of the acidic hydrogen atoms in the or each amphiphilic polymer. In some embodiments, the method may comprise deprotonating no greater than 98% of the acidic hydrogen atoms in the or each amphiphilic polymer, or no greater than 96, 94, 92, 90, 88, 86, 84, 82, or no greater than 80% of the acidic hydrogen atoms in the or each amphiphilic polymer.

Step (b) preferably comprises producing a coating of at least one amphiphilic polymer on the base film as described for the first aspect of the invention.

In some embodiments, the method further comprises the step of drying the coated film after step (b). The drying step may comprise oven drying or may preferably comprise air drying the coated film. The method may comprise drying the coated film at a temperature of at least 10° C., or of at least 12, 14, 16, 18, 20, 22, or of at least 24° C. The method may comprise drying the coated film at a temperature of no greater than 200° C., or of no greater than 180, 160, 140, 120, 100, 80, 60, or of no greater than 40° C. In a preferred embodiment, the method comprises air drying the coated film at room temperature and ambient pressure. In some embodiments, the method comprises drying the coated film, preferably at room temperature, for at least 30 seconds, or at least 1 min, or at least 2, 3, 4, 5, 10, 15, 20, 25, 30, 35, 40, 45, 50, or at least 55 mins, or for at least 1 h, or at least 2, 3, 4, 5, 10, 15, or at least 20 h, or for at least 1 day.

The method may comprise drying the coated film, preferably at room temperature, for no greater than 4 weeks, or no greater than 3, 2, or no greater than 1 week, or for no greater than 6 days, or no greater than 5, 4, 3, or no greater than 2 days.

According to a fifth aspect of the invention, there is provided a method of preparing the water-soluble unit dose article of the second aspect of the invention, the method comprising the step of: packaging a composition in a container comprising the coated water-soluble film of the first aspect of the invention.

Statements of invention above relating to the coated water-soluble film of the first aspect of the invention or to any of its components may also be applied to the fifth aspect of the invention.

Statements of invention above relating to the water-soluble unit dose article of the second aspect of the invention or to any of its components may also be applied to the fifth aspect of the invention.

The coated water-soluble film may be prepared by the method of the fourth aspect of the invention.

Where reference is made in the fifth aspect of the invention to any components of the coated water-soluble film referenced previously in the first aspect of the invention or to any components of the water-soluble unit dose article of the second aspect of the invention, statements of invention relating to the respective components for the first and second aspects of the invention may equally apply.

In some embodiments, the method comprises the step of forming the container comprising the coated water-soluble film before packaging the composition in the container. The step of forming the container may comprise forming the container from a single sheet of the coated water-soluble film or from two or more sheets of the coated water-soluble film.

The step of forming the container from a single sheet of the coated film may comprise: folding a single sheet of the coated water-soluble film over itself; and sealing the folded sheet at its edges to define an internal cavity in which the composition can be contained, in use. In some embodiments, the sheet may not be fully sealed in this step to allow for the composition to be inserted into the internal cavity before fully sealing the sheet. In an embodiment, the method may comprise folding the single sheet over onto itself; and sealing the folded sheet on the edge opposite the fold and along one of the two remaining open edges, to provide an open container.

In a preferred embodiment, the method comprises the step of forming the container using two water-soluble films, wherein at least one of the films is a coated film of the invention, as described for the second aspect of the invention. The method may comprise the step of sealing the two films together, preferably in sheet form, to define an internal cavity in which the composition can be contained.

In some embodiments, the method comprises stretching a coated water-soluble film over a cavity of a specified dimension; and heating the film under a vacuum to form the film into the shape of the cavity. The method may thereafter comprise filling the exposed cavity of the film (the open container) with the composition, followed by sealing the exposed cavity with a second film. The second film may be pulled over the top of the exposed cavity during the sealing step, and the edges of the second film may be sealed to the edges of the first film to provide a sealed container.

Any suitable known methods and machinery may be employed for forming and sealing the container comprising the coated water-soluble film of the invention. Suitable methods include but are not limited to: vertical, form, fill and sealing (VFFS); thermoforming; solvent sealing; and heat sealing.

### DETAILED DESCRIPTION OF THE INVENTION

In order that the invention may be more clearly understood embodiments thereof will now be described, by way of example only.

### EXAMPLES

### Example 1—Preparation of Coated Water-Soluble Films of the Invention

Coating solutions were prepared by dissolving amphiphilic copolymers, as described in Table 1 below, in ethanol at concentrations of 0.5-10 wt %. The solutions were subsequently neutralized with an aminomethyl propanol amine base till the pH of the resultant solution was between 7.5 and 9. Ethanol was chosen as the solvent for the coating solutions due to the insolubility of PVOH in ethanol. This allowed PVOH base films to be coated with the polymer solutions without dissolving the PVOH and disintegrating the base films.

The coating solutions were applied onto PVOH (SOLUBLON® GA film from Aicello, thickness 90 μm) by spraying the PVOH films with the coating solutions. The coated films were thereafter dried at room temperature.

This method resulted in thin layers of the amphiphilic copolymer coatings forming on the PVOH base film. The completeness and uniformity of the coating layers were determined by the uniform increase of film thickness from before to after coating.

Polymer coating loadings and coating thicknesses (using Constant Pressure Thickness Gauges, Peacock FFA-1 1.25) were measured/calculated, and are recorded in Table 1 below.

TABLE 1

| | | Polymer | |
|---|---|---|---|
| | | coating | Coating |
| | | loading | thickness |
| | Coating polymer | (mg/cm²) | (μm) |
| Film 1 | Octylacrylamide/acrylates/ | 1.32 | 11 |
| | butylaminoethylmethacrylate copolymer | | |
| Film 2 | Acrylates/t-butylacrylamide copolymer | 1.00 | 10 |
| Film 3 | Vinyl acetate/crotonates/vinyl | 1.21 | 10 |
| | neodecanoate copolymer | | |
| Film 4 | Butyl ester of vinyl methyl ether/maleic | 0.95 | 10 |
| | acid copolymer | | |

### Example 2-Preparation of Citric Acid Pouches and Stability Test

Eight different pouches were made using eight different PVOH films; including the four amphiphilic polymer coated PVOH films of the invention (films 1-4), one uncoated PVOH film (film 5), and three PVOH films coated with a hydrophilic material (films 6-8).

The following uncoated and hydrophilic material-coated films were used as controls: —Film 5: uncoated R GA PVOH film.

Film 6: PVOH modified by a gelatin layer. Gelatin film was prepared via solution casting by film applicator COATMASTER 510 from ERICHSEN, having a thickness of 20 μm. The gelatin film was placed between PVOH and citric acid when preparing the pouches.

Film 7: PVOH modified by hydrophilic bentonite. 5 g SOLUBLON® GA PVOH and 6.25 g hydrophilic bentonite were dissolved in 20 g water. The mixture was homogenized and coated on an existing SOLUBLON® GA PVOH by film applicator. The obtained coating layer had a rough surface and a thickness of 20 μm.

Film 8: PVOH modified by cellulose microcrystalline. 5 g SOLUBLON® GA PVOH and 6.25 g cellulose microcrystalline were dissolved in 20 g water. The mixture was homogenized and coated on an existing SOLUBLON® GA PVOH by film applicator. The obtained coating layer had a smooth surface and a thickness of 20 μm.

ca. 4 g of citric acid granules were filled into each of the eight pouches, and the pouches were sealed at 160° C.

Several pouches of film 1 were placed together in a single doypack. The same step was performed for pouches of each of films 2-8, which were also placed into their own respective doypacks. The doypacks were stored at 40° C. and 75% room humidity for up to 6 weeks.

Aesthetics and solubility evaluations were carried out, and the results are recorded in Table 2.

TABLE 2

| | | Aesthetic | Solubility |
|---|---|---|---|
| | Coating/modifying material | score^{(a)} | score^{(b)} |
| Film 1 | Octylacrylamide/acrylates/ | 4 | 5 |
| | butylaminoethylmethacrylate copolymer | | |
| Film 2 | Acrylates/t-butylacrylamide copolymer | 5 | 5 |
| Film 3 | Vinyl acetate/crotonates/vinyl | 3 | 2 |
| | neodecanoate copolymer | | |
| Film 4 | Butyl ester of vinyl methyl ether/maleic | 3 | 2 |
| | acid copolymer | | |
| Film 5* | (untreated film) | 1 | 1 |
| Film 6* | Gelatin | 1 | 1 |
| Film 7* | Hydrophilic bentonite | 1 | 1 |
| Film 8* | Cellulose microcrystalline | 1 | 1 |

^{(a)}Aesthetics evaluations: 5-smooth pouch surface; 4-slightly cratered pouch surface; 3-sticky pouches with cratered surface; 2-pouches stick together, hard to take apart without breaking the pouches; 1-pouches stick together, very hard to take apart.
^{(b)}Solubility evaluations: 5-dissolved at 25° C.; 4-dissolved at 40° C.; 3-dissolved at 60° C.; 2-dissolved at 80° C.; 1-insoluble at 80° C.
*Storage stopped at 3 weeks due to low score of evaluation.

### Summary of Results

Amphiphilic coatings (films 1-4) help to form a barrier layer, blocking contact between PVOH and citric acid. As such, the PVOH is protected against undesired reactions with the citric acid during storage and thus the film retains good solubility.

Inventive films containing an octylacrylamide/acrylates/butylaminoethyl methacrylate copolymer, an acrylates/t-butylacrylamide copolymer, or a butyl ester of vinyl methyl ether/maleic acid copolymer (films 1, 2, and 4) retained solubility even in cold water after long-term storage. These films also advantageously completely disintegrated on film dissolution.

Whilst the vinyl acetate/crotonates/vinyl neodecanoate copolymer (film 3) coating could not stop the crosslinking reaction between the PVOH and citric acid from occurring completely, it was able to slow down the reaction to allow for reasonable solubility after long-term storage.

Uncoated PVOH and PVOH modified with hydrophilic materials (films 5-8) reacted with citric acid easily and became completely water insoluble after only 3 weeks of storage.

In summary, thin layers of amphiphilic polymer coatings on PVOH bring both aesthetics and solubility benefits to PVOH/citric acid pouches, i.e. non-stickiness and retained solubility.

The invention not only solves the compatibility issue of PVOH and citric acid, but also provides insight into improving the compatibility of PVOH with other reactive chemicals, allowing for the development of many new valuable formulae and products.

The above embodiments are described by way of example only. Many variations are possible without departing from the scope of the invention as defined in the appended claims.

1. A coated water-soluble film comprising:
a water-soluble polymer base film; and
a water-soluble coating comprising at least one amphiphilic polymer;
wherein the base film comprises polyvinyl alcohol, wherein the coating comprises:
at least one amphiphilic copolymer comprising at least one hydrophilic monomer being an acidic monomer, an anionic monomer, or combinations thereof; and
at least one hydrophobic monomer, wherein the at least one hydrophobic monomer is an alkyl acrylamide monomer, an alkyl acrylate monomer, an alkyl alkacrylate monomer, an alkylaminoalkyl acrylate monomer, an alkylaminoalkyl alkacrylate monomer, a vinyl alkanoate monomer, a vinyl alkyl ether monomer or monoester derivative thereof, a vinylpyrrolidone monomer or derivative thereof, an alkylene glycol alkacrylate, or any salts, derivatives or combinations thereof.

2. The coated water-soluble film according to claim 1, wherein the coating is present on at least 50% of a surface of the base film, and/or wherein the coating is uniformly distributed on the surface of the film.

3. The coated water-soluble film according to claim 1, wherein the base film has a thickness of at least 40 μm.

4. The coated water-soluble film as claimed in claim 3, wherein the polymer coating comprises a layer with a thickness of no greater than 40 μm.

5. A water-soluble unit dose article comprising a composition packaged in a container comprising the coated water-soluble film of claim 1.

6. The water-soluble unit dose article as claimed in claim 5, wherein the composition comprises a reactive chemical selected from an acid, an oxidant, a base, a bleach, an aldehyde, or combinations thereof; wherein the reactive chemical comprises a solid acid with more than one carboxylic acid group.

7. The water-soluble unit dose article as claimed in claim 5, wherein the coated water-soluble film is in direct contact with the composition.

8. Use of a water-soluble unit dose article of claim 5 as a hard surface cleaner, a descaler, a toilet cleaner, a dishwashing machine cleaner, a household care composition, or a multi-purpose cleaner.

9. A method of preparing a coated water-soluble film of any one of claims 1 to 4 claim 1, the method comprising the steps of:
a. Providing a water-soluble polymer base film; and
b. Coating the base film with at least one amphiphilic polymer.

10. The method of preparing a coated water-soluble film as claimed in claim 9, wherein step (b) comprises spray-coating the base film with the at least one amphiphilic polymer.

11. The method of preparing a coated water-soluble film according to claim 9, wherein the following subsequently executed method steps are additionally comprised between method steps (a) and (b):
i) providing an amphiphilic polymer
ii) dissolving said amphiphilic polymer in a non-aqueous solvent;
iii) neutralization of the resulting amphiphilic polymer solution, wherein the degree of neutralization is ranging from 40-100%.

12. The coated water-soluble film according to claim 1, wherein the coating comprises a non-hydroxyl functionalised polymer.

13. The coated water-soluble film according to claim 2, wherein the coating is uniformly distributed on the surface of the film at a loading of between 0.2-5 mg/cm².

14. The water-soluble unit dose article according to claim 5, wherein the container comprises two of the water-soluble films sealed together to define an internal cavity in which the composition is contained.

15. A method of preparing a coated water-soluble film according to claim 11, wherein in method step ii) the non-aqueous solvent is a mixture of at least two alcohols.

16. A method of preparing a coated water-soluble film according to claim 11, wherein in method step iii) the neutralization of the resulting amphiphilic polymer solution is executed by the addition of an amine.
